(19) United States
(12) Patent Application Publication
(10) Pub. No.: US 2011/0299798 A1
(43) Pub. Date: Dec. 8, 2011

(54) Bag with Structure for Avoiding Bricking Appearance

(76) Inventors: Stephen Graham Coulson, Mississauga (CA); Michael Reid Martin, Toronto (CA)

(21) Appl. No.: 12/794,886

(22) Filed: Jun. 7, 2010

(51) Int. Cl. B65D 33/01; B31B 49/04; B65D 30/08

(52) U.S. Cl. 383/103; 383/113; 493/267

(57) ABSTRACT

A bag structure has a hermetically sealed bag with an outer ply sealed to the bag to define a cavity. The cavity is bounded on one side by a part of the bag and bounded on another side by the outer ply. Perforations are formed through the outer ply to permit passage of gas from the atmosphere into and out of the cavity to reduce unsightly bricking. A one-way valve is formed in the hermetically sealed bag to permit passage of gas from the interior of the bag.

### FIELD OF THE INVENTION

This invention relates to bags for materials such as foodstuffs and particularly to a bag structure for inhibiting poor bag appearance owing to bricking of the bag and contents.

### DESCRIPTION OF RELATED ART

Bags are known for storing foodstuffs and similar materials in which there is venting from the bag interior either to permit the escape of air as the bag is being filled or to permit the escape of gases which may be produced over time by materials in the bag. Typically, a one-way valve is used which allows the escape of gas from inside the bag, but substantially prevents the ingress of air and other material which might contaminate the contents of the bag. Other venting means have taken the form of micro-perforations through the material of the bag, the micro-perforations being large enough to permit the escape of gas but not so large as to permit the loss of foodstuffs or other material contained in the bag. Yet other known bag vents have been installed in the course of the bag production process by implementing a seal—for example, at a contact region between adjacent bag liner parts—which is deliberately constructed to be less than perfect as a seal. Examples of such seals leave air passages of relatively small cross-section and generally of non-linear form along which gas can pass from the bag interior to its exterior.

While such bag arrangements have been effective in avoiding the build up of gases in the interior of the bag which can distort the bag appearance, cause stacking problems, and even result in rupture, known vent arrangements have not addressed “bricking”. Bricking is the phenomenon of granular or like bag contents taking on the appearance of a brick, this being particularly noticeable when bags are moved from a low to a high pressure environment or have been stored under pressure.

### SUMMARY OF THE INVENTION

According to one aspect of the invention, there is provided a bag structure comprising a hermetically sealed bag and an outer ply bonded to the bag to define a generally flat cavity bounded on one side by a part of the bag and bounded on another side by the outer ply, a passage between the cavity and the exterior of the bag structure to permit passage of gas between the atmosphere and the interior of the cavity, and a one-way valve formed in the bag to permit escape of gas from the interior of the bag.

Preferably, the valve is formed in a first part of the bag and extends through both said first part of the bag and the outer ply to permit escape of gas from the interior of the bag directly to the atmosphere. However, the valve can alternatively extend only through said first part of the bag to permit escape of gas from the interior of the bag to the cavity, with the passage permitting gas from the bag interior to vent from the cavity to the atmosphere. The bag and the outer ply can be formed from thermoplastic sheet materials that are bonded together by heat sealing. Alternatively, the bag and the outer ply can be bonded using adhesive.

The bag is preferably formed from heat sealable thermoplastic sheet material and includes a barrier layer such as layer of EVOH, a metal layer or a vacuum deposited metalized coating. The thermoplastic sheet material can be a low density polyethylene and the bag structure can be formed throughout of thermoplastics sheet material. In one structure, the bag can have a front panel, a back panel, and side gusset panels, the outer ply extending over at least of one of the front and back panels. The passage can comprise one or more holes such as an array of micro-perforations. Alternatively, the passage can be formed by a less than perfect sealing where the outer ply is bonded to the bag.

According to further aspect of the invention, a method of manufacturing a bag structure as previously described comprises perforating a first web of thermoplastics sheet material, overlapping a second web of thermoplastics sheet material with the first web, installing a valve to extend through the overlapping webs, heat sealing the webs together over a first area of overlap, the first area of overlap extending around a second area of overlap to leave the webs separated at the second area thereby to define a generally flat cavity, with the perforations and the valve within said second area.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a perspective view of a bag structure according to one embodiment of the invention.

FIG. 2 is a sectional view through a part of the bag structure of FIG. 1.

FIGS. 3 and 4 show sectional views of a valve suitable for use in a bag structure according to an embodiment of the invention, the valve shown in successive phases of operation.

FIG. 5 shows a plan view of the valve of FIGS. 3 and 4.

FIG. 6 is a sectional view through a bag structure according to another embodiment of the invention.

### DETAILED DESCRIPTION OF THE INVENTION INCLUDING THE PRESENTLY PREFERRED EMBODIMENTS

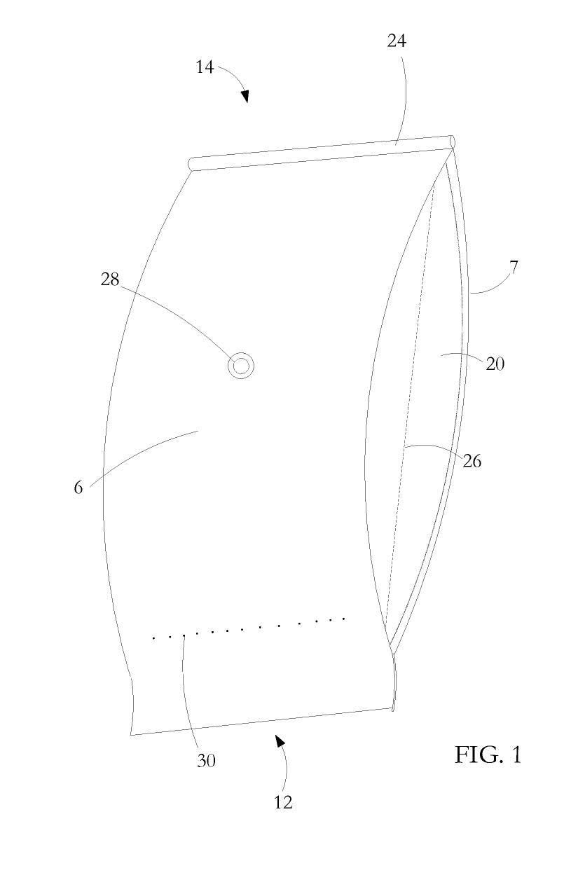

Referring to FIG. 1, a pouch form bag according to one embodiment of the invention has opposed ends 12, 14, front and rear 6, 7, and opposed side panels 20 sealed to and extending between the front and rear. End 14 of the bag has a press-to-close closure arrangement 24 which enables opening and closing of the end 14. The end 14 can alternatively be sealed during manufacture if the bag is to be filled from the other end 12, left open if the bag is to be sealed following filling at the end 14, or can use an alternative closure arrangement such as a slider zipper. The end 12 can be left open at the end of bag manufacture to allow for later filling and then sealing, or is sealed off during manufacture if the bag is to be filled from the end 14. The side panels 20 each provide a gusset region by being folded along their length as shown at 26. It will be understood that the pouch bag is just one form of bag structure in which the invention can be embodied. Bags having other shapes, panels, closures, folds, reinforcements, gussets, materials, etc., can all use the principles of the invention. The plastic bag of FIG. 1 is suitable for storing granular or piece part foodstuffs or similar materials.

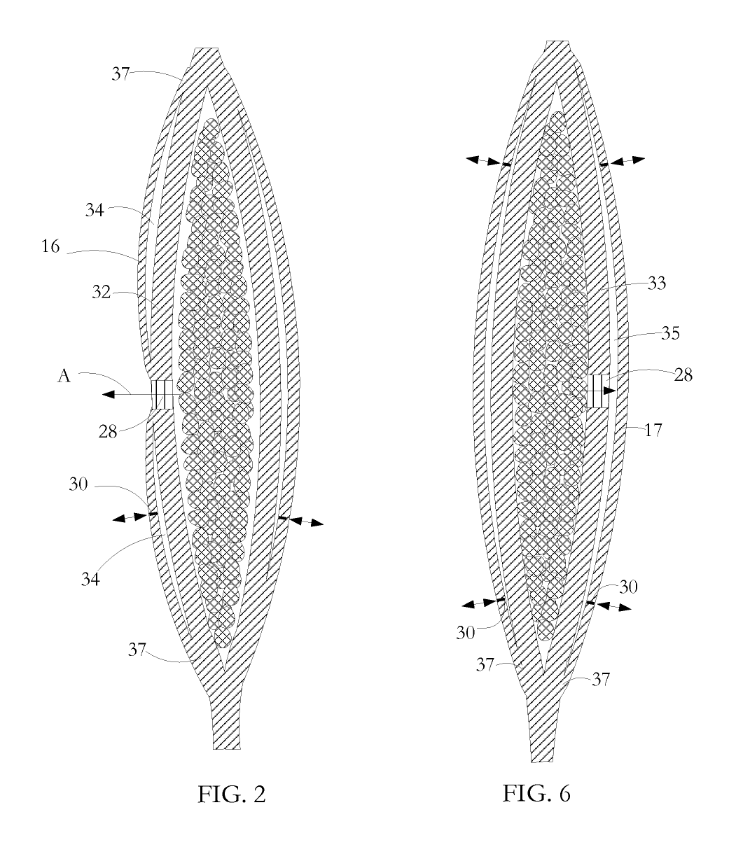

As shown in the vertical sectional view of FIG. 2, the bag structure at its front side has a panel 32 to which is sealed an outer ply 16 to form the front of the bag structure. At its rear side, the bag structure has a panel 33 to which is sealed an outer ply 17. The outer plies 16, 17 are sealed at edge regions 37 to respective underlying substrates formed by the front and rear panels 32, 33. Inside the sealing area, the outer plies are separate from but extend closely adjacent to the respective front and rear panels to form narrow cavities 34, 35. The panels 32, 33 and 20 together form a hermetically sealed bag, while the overlying front and rear plies 16, 17 do not contribute significantly to the bag's hermetically sealed nature.

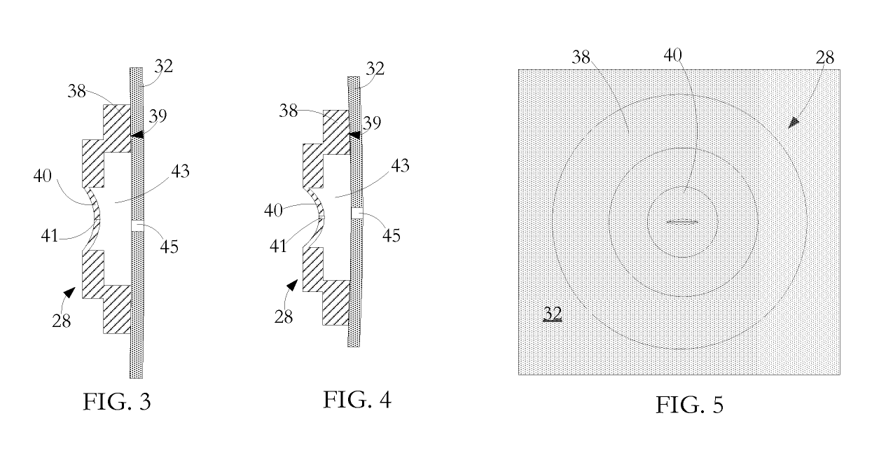

At the front of the bag structure, a one-way valve 28 is mounted to the panel 32. The valve 28 permits the exit of gas from the interior of the bag to the exterior of the bag as shown by arrow A, but does not permit the passage of air or other gaseous material from the outside of the bag into the bag interior. As shown in FIGS. 3, 4 and 5, a suitable one-way valve for the application of the invention has a rigid annular supporting ring 38 with a face 39 bonded to the material of the panel 32. Integral with the annular ring 38 is a flexible membrane 40, the membrane formed with a domed central region in which a slit 41 is formed. The membrane is adapted to flex from a rest position as shown in FIG. 3 to the position shown in FIG. 4 when the pressure on the left side of the membrane as shown in the figures exceeds the pressure on the right side of the membrane by a preset amount depending on the dimensions and stiffness of the membrane. Flexure of the membrane causes the slit to open as shown in FIG. 4 and by the broken line representation of FIG. 5. When the pressure difference across the membrane 40 is sufficiently reduced, the elasticity of the membrane material causes the membrane to revert to its initial condition and the slit 41 closes. Alternative designs of one-way valve can be used depending on the mechanical and operational properties that are required, such valves using different materials and operational dynamics to effect the pressure-related opening and closing. In each case, depending on the application and the valve type, the one-way valve 28 is configured to begin opening at a predetermined overpressure of the bag interior pressure relative to the pressure prevailing outside the bag. Opening of the valve permits gas to escape from the bag interior into a chamber 43 and to escape through a hole 45 punched through the panel 32 and the overlying ply 16 resulting in the internal pressure in the bag being lowered. When the overpressure falls to a second predetermined overpressure less than the first overpressure, the membrane is restored to a condition preventing air from passing back through the valve into the interior of the bag. As indicated, valves with different opening and closing overpressures can be used for particular applications as warranted by the nature of the bag contents and the pressure conditions which the bag is expected to experience.

Formed in each of the outer plies 16 and 17 are arrays of perforations 30. As shown in FIG. 1, the perforations are formed as a linear array in the outer ply 16 but may be formed as a differently configured array and may be more widely distributed over the bag surface. The perforations permit equalization of pressure across each of the front and rear plies 16, 17. Pressure balancing occurs over time for example as the bag is being transported between regions of different air pressure such as up a mountainside or by airplane. Balancing can also occur after a full bag has been subjected to significant pressure such as happens if bags have been stacked together and squeezed between overlying and underlying bags. The balancing of air pressures occurs automatically as the result of the difference in pressures and, especially if supplemented by some flexing of the bag panels and outer plies, the original appearance of the bag can be at least partially restored, with unsightly bricking artifacts disappearing or being significantly reduced. The exact position of the perforations on the outer plies of the finished bag structure is not important provided that they extend through the outer plies bounding cavities 34, 35. In other respects, the position of the perforations is selected for desired appearance and in dependence on the intended location of graphic design elements to be applied to the outer ply. The flow rate of air required to achieve pressure balancing is relatively small, so a micro-perforation size in the range 0.05-0.1 mm. is quite satisfactory and is in fact for aesthetic reasons preferred over larger perforations since smaller perforations are neither easy to see nor prone to ingress of foreign substances. It will be appreciated that other forms of vents can be formed in the outer plies using for example reciprocating punches and dies to form holes, slits or other vent shapes. Although micro-perforations are preferred, larger holes can be contemplated where the passage of minor contaminants through the outer plies of the bag structure is not of real concern. However, the holes should not be so large as to affect the integrity of the bag structure or to risk the bag being caught and torn at a hole. Although the edge form of the holes is not important, neater perforations can be obtained if desired using laser cutting as an alternative to a mechanical punching action.

As is evident from FIG. 1, whereas when viewed from the outside, the bag structure appears to have a single ply, it actually has dual plies over a large part of each of the front and back. The visible parts of the outer plies 16, 17 in fact define part of a false bag in the sense that, although they may be sealed to the respective underlying panels 32, 33 and may be printed with product and handling literature and graphics, they do not in fact contact the contained commodity when the bag is full. As shown in FIG. 2, the outer plies 16, 17 are heat sealed at selected regions 37 to the panels 32, 33, with the panels 32, 33 and 20 together forming a hermetically sealed container for storing foodstuffs and like materials.

In the embodiment of FIG. 2, the one-way valve extends through both the panel 32 and the outer ply 16. In an alternative embodiment shown in FIG. 6, the valve 28 extends only through the panel 33 and, in use, the valve 28 vents into the cavity 35 between the panel 33 and the bag outer ply 17 rather than venting directly to the atmosphere. While the end point is the same, since any gas vented into the cavity 35 can escape through the perforations 30, this structure is somewhat more difficult to manufacture because the valve 28 has to be mounted in a web from which the panel 33 is formed before this web and a web from which the outer ply is formed are sealed together. Consequently, more careful handling during the sealing process is required.

In each of the illustrated embodiments, the material of the bag and the material of the outer plies are heat-sealable thermoplastic film materials and sealing is effected by heat sealing. Heat sealing and bonding of layers of thermoplastic sheet material are obtained by the application of temperature and pressure for a predetermined time at locations where the layers are to be sealed. Particular temperature, pressure and time are selected based on the nature of the sheet materials being bonded together. Bonding is typically performed at multiple bonding stations in the course of the manufacturing process, with the bonded material subsequently being cooled.

A variety of sheet materials may be used in the construction of bags according to the invention, depending on the properties which are required. The sheet materials are preferably plastics but can alternatively be formed from non-plastics, such as paper. In the case of plastics, the sheet material can be a thermoplastic which enables heat sealing or can be non-thermoplastics which may require adhesives for sealing. It will be appreciated that the desired properties of the inner bag may be quite different from the required properties of the outer plies and, to this extent, the sheet materials used can have different material and mechanical properties. Plastic sheet materials may include, by way of example and not limitation, polyolefins such as polyethylene and polypropylene, polyesters, vinyl polymers, and the like. The materials may be low-, medium- or high-density polymers and may be single or multi-layer composite material. Composite laminated sheet materials may include adhesive layers and co-extruded sheet materials may include tie layers. Sealing resins may be used to improve sealing of certain polymer layers.

The type of thermoplastics or other sheet material chosen for the bag structure may depend on any or all of the purposes to which the bag is to be put, whether it is easy to handle in manufacturing, whether it can be readily printed upon, whether it is waterproof, and whether it is strong enough to resist tearing or bulging, etc.

The particular selection of ply materials and the number of layers of each material is chosen for the particular properties desired in the bag. Thus, polyethylene has good heat sealing properties and relatively high strength. A copolymer polyethylene with high elastomeric content can be used where a softer material is required. The materials of the bag web and the ply web are selected to achieve required physical properties depending on the particular application including the weight and type of materials to be contained in the bag and the expected environmental conditions. For example, thermoplastic films can be used which have been oriented during manufacture to impart particular mechanical strength in the liner or the bag or at critical stress sites. Such oriented strength can be imparted, as is known, by for example stretching at ambient temperatures, melt orienting during extrusion, etc.

The invention contemplates the use of plastic films which are made of, or which include, a barrier sheet material for preventing the transmission of gases such as oxygen. Particularly for the hermetically sealed bag parts, the material should contain a barrier layer to prevent the seeping through the film of oxygen and other gases that may damage foodstuffs contained in the bag. For some applications, a barrier layer of EVOH (ethylene vinyl alcohol copolymer) is preferred since it permits the construction of an aesthetically pleasing transparent liner. For other applications, a metalized barrier layer can be used. The thickness of the sheet film material is selected mainly on the basis of the intended weight the bag must carry and generally ranges from about 2 to 20 mils.

For bags that are to be subjected to high temperature and/or high humidity, a barrier layer that has a higher resistance to oxygen diffusion is used. In one such embodiment, the inner material is a 3 layer laminate consisting of a central metalized polyester layer bonded to flanking layers of linear low density polyethylene. In a further embodiment, the inner material is a 2 layer laminate consisting of an outer layer of metalized polyester bonded to an inner layer of polyethylene. In each of the alternative embodiments, wherever metalized polyester to polyethylene bonding is required, the surfaces may be bonded together using an adhesive instead of heat sealing. To improve adhesion of polyethylene to metalized polyester, the surface of the polyethylene layer to be bonded is subjected to corona treatment.

In the process for manufacturing the bag structure of FIG. 2, a first web of plastic sheet material, the bag web, is used to form the panels 32, 33 and 20 of the part of the bag structure to function as the hermetically sealed bag. Second webs of plastic sheet material, the outer ply webs, are used to form the outer plies 16, 17. The outer ply webs are first brought to a perforating station where they are momentarily halted and pierced with a line of circular micro-perforations by using a reciprocating punch arrangement. The outer ply webs can alternatively be punctured, without halting, by bringing the outer ply webs from a delivery roller around a guide roller formed with a series of sharp studs and then to a take-off roller. The bag web and the outer ply webs are then brought into overlapping relationship. A hole is punched through the overlapping webs and a one-way valve 28 is sealed to the overlapping webs at the hole. The overlapping bag web and outer ply webs are then cut, folded and sealed in the course of finishing the individual bag structures. In an alternative manner of achieving the air passage between the atmosphere and the cavity 35, the outer ply is bonded to the hermetically sealed bag by a less than perfect seal, either by not sealing completely over the area surrounding the cavity in the case of heat bonding, or by selective placement of adhesive in the case of adhesive bonding.

In the course of manufacturing the embodiment illustrated in FIG. 2, the perforations are formed in each outer ply web and the valve is mounted at the bag web. In a variation of the process, a first web is used to form an outer bag comprising the gusset panels 20 and the outer plies 16, 17, and a second web is used to form an inner lining comprising at least a part of the panels 32, 33, the two webs then being sealed together as described with reference to the embodiment of FIG. 2. It will be appreciated that depending on the practical requirements previously discussed, many combinations of sheet material are possible for the various elements of the bag, with webs of the different types of material being subjected to appropriate processing, including cutting and sealing, as part of the production process.

As previously described, the bag structure is of particular value for a bag which is to contain foodstuffs. For other purposes and for containing other materials, certain design elements may be changed, while still maintaining a design and function according to the invention. For example, if desired, more or less than the front and back panels can be overlain with perforated outer plies to create cavities for reducing bricking effects. In addition, although it is convenient to form the one-way valve 28 in the front or back panel, the valve can just as readily be formed in another part of the bag such as the gusset area or in a selected area of the bag which does not have an outer ply. The one way valve is thicker than the bag panel material in which it is mounted so that if valves are located at the same corresponding position in all bags, it will be difficult to stack a number of bags as an even pile. To obtain a substantially uniform stack, the valve position can be randomly varied from bag to bag.

There have been described herein various embodiments of a bag structure for alleviating deterioration in bag appearance arising from bricking. Also described are particular production process steps involved in manufacturing such a bag structure. Such embodiments and processes have features that distinguish the present invention from the prior art. It will be apparent to those skilled in the art that the bag and manufacture of the disclosed invention may be modified in numerous ways and may assume many embodiments other than the preferred forms specifically set out and described above. Accordingly, it is intended by the appended claims to cover all modifications of the invention which fall within the scope of the invention.

What is claimed is:

1. A bag structure comprising a hermetically sealed bag and an outer ply bonded to the bag to define a generally flat cavity bounded on one side by a part of the bag and bounded on another side by the outer ply, a passage between the cavity and the exterior of the bag structure to permit passage of gas between the atmosphere and the interior of the cavity, and a one-way valve formed in the bag to permit escape of gas from the interior of the bag.

2. The bag structure of claim 1, the passage comprising at least one hole through the outer ply.

3. The bag structure of claim 1, the valve formed in said part of the bag.

4. The bag structure of claim 3, the valve mounted to said part of the bag and to the outer ply to permit escape of the gas from the interior of the bag directly to the atmosphere.

5. The bag structure of claim 3, the valve extending through said part of the bag to permit escape of the gas from the interior of the bag to the cavity, and the passage permitting gas that has escaped from the bag interior into the cavity to vent from the cavity to the atmosphere.

6. The bag structure of claim 1, the bonding between the outer ply and the bag effecting a seal between the outer ply and the bag other than at an area thereof defining the passage between the cavity and the exterior of the bag structure.

7. The bag structure of claim 1, the outer ply and the bag formed of plastic sheet material, the bag bonded to the outer ply by heat sealing.

8. The bag structure of claim 1, the bag bonded to the outer ply by an adhesive.

9. The bag structure of claim 7, the plastic sheet material including a barrier layer.

10. The bag structure of claim 9, the barrier layer including an EVOH layer.

11. The bag structure of claim 9, the barrier layer including a metalized layer.

12. The bag structure of claim 7, the plastic sheet material including a low density polyethylene layer.

13. The bag structure of claim 7, the plastic sheet material including a metalized polyester layer.

14. The bag structure of claim 1, the bag structure formed throughout of plastic sheet material.

15. The bag structure of claim 1, the bag having a front panel, a back panel, and side gusset panels, the outer ply located over a part at least of one of the front and back panels.

16. A method of manufacturing a bag structure comprising perforating a first web of plastic sheet material, overlapping a second web of plastic sheet material with the first web, installing a valve to extend through at least the second web, sealing the webs together over a first area of overlap, the first area of overlap extending around a second area of overlap to leave the webs separated at the second area thereby to define a cavity, with the perforation within said second area.

17. The method of claim 16, further comprising sealing the webs together over the first area of overlap to define the cavity with the valve within the second area.

18. The method of claim 16, further comprising installing the valve to extend through both of the first and second webs.

19. The method of claim 16, further comprising combining the webs successively to form bag structures as claimed in claim 1, the method further comprising, in successive manufacturing of substantially identical bag structures, varying the position of installing of the valve as between one bag structure and a succeeding bag structure.
